(19) United States
(12) Patent Application Publication
(10) Pub. No.: US 2022/0129737 A1
(43) Pub. Date: Apr. 28, 2022

(54) SYSTEMS AND METHODS FOR IMPROVING COMPUTER OPERATION WITH FASTER NEURAL NETWORKS

(71) Applicant: Amazon Technologies, Inc., Seattle, WA (US)

(72) Inventors: Kesavsundar Gopalakrishnan, Seattle, WA (US); Qiuping Xu, Seattle, WA (US)

(21) Appl. No.: 17/083,042

(22) Filed: Oct. 28, 2020

(51) Int. Cl. G06N 3/04; G06N 3/08; G06F 9/50

(52) U.S. Cl. CPC G06N 3/0481; G06F 9/5027; G06N 3/08

(57) ABSTRACT

System and methods are provided that can address a slowdown during neural network execution. The machine learning system precomputes values at the input layer that are not going to change for subsequent inferences. Using the precomputed values during execution reduces the computation costs for determining inferences in neural networks. Some of the improved neural networks are configured to maximize performance of an agent. Further, some of the improved neural networks are configured to process multiple agents where the input layer is configured to receive agent feature vectors in the input layer.

### BACKGROUND

The pace of adoption of artificial neural networks, usually simply referred to as neural networks, has been rapid. The application of neural networks in various contexts, such as computer vision, speech processing, natural language processing, and information retrieval, has seen remarkable successes. Neural networks are trained by processing input, forming probability-weighted associations, and storing the weighted associations within the data structure of the neural network itself. A deep neural network is a neural network with multiple layers between the input and output layers. Execution of a neural network results in output, which can be referred to as a prediction or inference. The process of executing the neural network can include many computations. Thus, using a neural network, especially deep neural networks, can cause the computer system to slow due to the sheer number of computations that occur as a part of the computer system executing the neural network.

### BRIEF DESCRIPTION OF THE DRAWINGS

These and other features, aspects and advantages are described below with reference to the drawings, which are intended for illustrative purposes and should in no way be interpreted as limiting the scope of the embodiments. Furthermore, various features of different disclosed embodiments can be combined to form additional embodiments, which are part of this disclosure. In the drawings, like reference characters can denote corresponding features throughout similar embodiments. The following is a brief description of each of the drawings.

FIG. 1 is a schematic block diagram depicting an illustrative network environment for implementing a machine learning system.

FIG. 2 is a schematic diagram depicting an illustrative general architecture of a computing system for implementing the deployment instance referenced in the network environment depicted in FIG. 1.

FIG. 3 is a schematic diagram depicting an example neural network.

FIG. 4 is a schematic diagram depicting another example neural network.

FIG. 5 is a flow diagram depicting an example method for faster execution of neural networks.

### DETAILED DESCRIPTION

As described above, neural networks can be applied in various contexts and the execution of a neural network results in output, which can be referred to as a prediction or inference. Executing a neural network can include many function evaluations, which can cause a slowdown by a computer system executing the neural network to get output from the neural network. An optimization problem refers to the problem of selecting the best element (with regard to some criterion) from some set of available alternatives. Optimization problems in neural networks can also suffer from a large number of function evaluations, which can also cause a slowdown. For example, in neural networks, an expression of the learned function(s) that can be analyzed may be unknown and its derivative(s) may likewise be unknown. Thus, evaluation of a function typically requires providing input to the neural network and getting output from the neural network. The previously mentioned bottlenecks can be especially troublesome in the context of reinforcement learning.

A neural network can include an input layer, one or more intermediate layers (which can also be referred to as hidden layers), and an output layer. In the neural network, each node (which can also be referred to as a neuron) or input from the input layer can be connected with each node from the next layer and each connection can have a particular weight. Each node can calculate a combined value from the weighted sum of the inputs and a bias (a constant). The combined value is fed into an activation function at the node. The activation function defines if a given node should be “activated” or not based on the combined value. The activation function can be a mathematical gate between the input feeding the current node and the current node's output going to the next layer. The activation function can be a step function that turns the node output on and off, which can depend on a rule or threshold. Another example activation function can include a transformation that maps the input signals into output signals that are needed for the neural network to function.

Input to the neural network can be a feature vector. Feature vectors can represent numeric or symbolic characteristics, called features, of an object in a mathematical format. The feature vector can be a series of values, such as numbers. An example feature vector X can be represented as [x₁, x₂, . . . , xₙ].

Neural networks can be used with reinforcement learning. Reinforcement learning is an area of machine learning concerned with how agents ought to take actions in an environment in order to maximize the notion of cumulative reward. An agent learns to achieve a goal in an uncertain, potentially complex environment. The goal of reinforcement learning can include finding an optimal policy that maps input states to actions of the agent. The improved neural networks described herein can be applied to reinforcement learning. However, the improved neural networks described herein can also be applied to any context involving neural networks where some of the input to the neural network remains static for multiple inferences.

Generally described, aspects of the present disclosure are directed to systems and methods that can improve the execution time of neural networks by computing systems. Instead of performing the same repeated calculations during execution, improved systems and methods can precompute values that are not going to change from the input layer to the next layer for multiple inference requests. As described herein, using the precomputed values can also reduce the computation costs for the optimization problems in neural networks. In some examples, the techniques described herein for accelerating neural network execution can be twenty-four or one-hundred and eighty times faster than existing execution methods. As another example, the techniques described herein for reducing the computational burden of executing neural networks on a computer system can advantageously enable a neural network to be executed on a single computer system or host; whereas, execution of existing neural networks may be so computationally expensive that it necessitates execution on multiple hosts to be completed. Therefore, the techniques described herein can advantageously result in faster computation on a computer system and/or can use less computational resources of the host(s).

In reinforcement learning, neural networks can be used to make one or more decisions in an environment. Environmental input can be referred to as state or states and can be denoted as S. The actions of an agent can be denoted as A. Using this notation, the goal of reinforcement learning is to find an optimal policy that maps states S to actions A of the agent, policy (π):S→A.

As described above, some existing systems are limited in various ways, and various embodiments of the present disclosure provide significant improvements over such systems, and practical applications of such improvements. For example, the techniques described herein can result in significantly faster execution of neural networks. As another example, the techniques described herein for improved neural networks can result in significantly reduced computational costs such that less hosts (such as a single host) can be used to execute an improved neural network where executing an existing neural network to get the same output as the improved neural network would otherwise require multiple hosts. Thus, the systems and techniques described herein can result in improvements in the functioning of computer system itself. The improvements to the functioning of the computer itself to perform computations can be expressed in Big O notation, as described herein. Moreover, embodiments of the present disclosure can be inextricably tied to, and provide practical applications of, computer technology.

As used herein, in addition to its ordinary and customary meaning, “argmax” or “arg max” is an operation that finds the argument that gives the maximum value from a target function. An example optimal policy can be defined as π*=argmax_{a∈A}V(S,A), where V is the reward function that maps from the states S and actions A to metrics that agent tries to optimize. To learn the optimal policy and/or solve an optimization problem, there would be large number of function evaluations of V(S,A). The techniques and approaches described herein can reduce the computation costs for evaluation, specifically in the case where neural networks are used as an estimator for the reward function V(S,A).

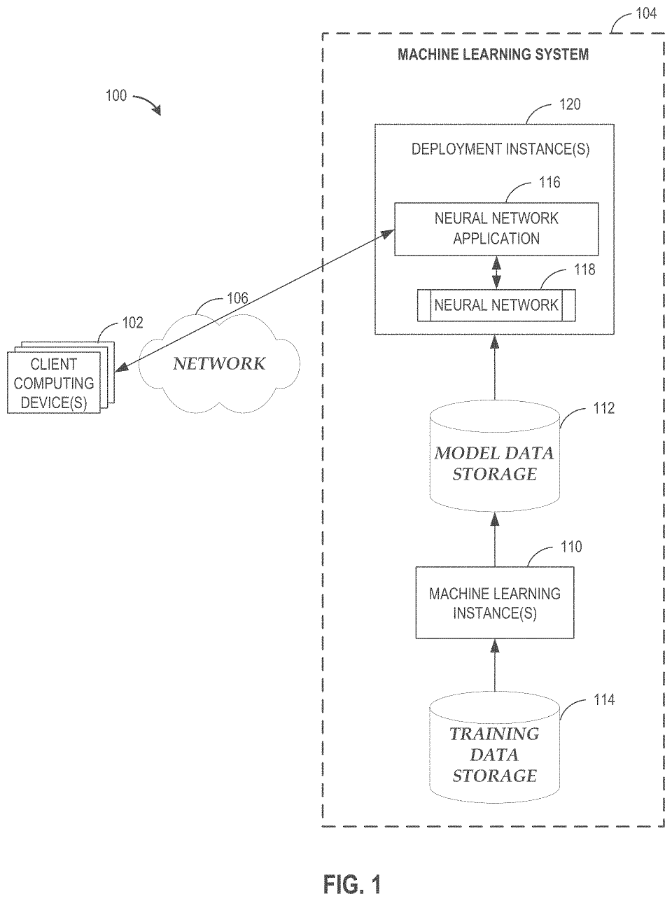

Turning to FIG. 1, an illustrative network environment 100 is shown in which a machine learning system 104 may train and execute a neural network. While the present disclosure uses the network environment 100 as an example, the techniques described herein for improved neural networks can be applied to other environments. The network environment 100 may include one or more client computing devices 102 and the machine learning system 104. The machine learning system 104 may include a training data storage 114, one or more machine learning instances 110, a model data storage 112, and one or more deployment instances 120. The one or more deployment instances 120 can execute a neural network application 116 that communicates with a neural network 118, which can be retrieved from the model data storage 112. The constituents of the network environment 100 may be in communication with each other either locally or over a network 106. While certain constituents of the network environment 100 are depicted as being in communication with one another, any constituent of the network environment 100 can communicate with any other constituent of the network environment 100; however, not all of these communication lines are depicted in FIG. 1. For example, the deployment instance(s) 120 can communicate with the training data storage 114.

Example client computing devices 102 can include a laptop or tablet computer, personal computer, personal digital assistant (PDA), hybrid PDA/mobile phone, smart wearable device (such as a smart watch), mobile phone, and/or a smartphone. Another example client computing device 102 can be a computer in a vehicle. The client computing device 102 can interact with the machine learning system 104 and, in particular, the deployment instance(s) 120. In a search context, a user can submit, via the client computing device 102, a search to the machine learning system 104, which can be processed by the deployment instance(s) 120. In particular, the client computing device 102 can essentially communicate with the neural network application 116, which can return output in an accelerated manner that is used by the deployment instance(s) 120. The deployment instance(s) 120 can retrieve and return the query results to the client computing device 102. A user can interact with the query results, such as by acquiring an item from the query results, which can be referred to herein as a conversion. The user interaction data (such as the search text and conversion data) can be stored in the training data storage 114 and used for machine learning and training purposes. While a search context is used as an example herein, the machine learning system 104 can be applied to other contexts.

In some embodiments, the output of the neural network 118 can affect the deployment instance(s) 120. The output of the neural network 118 can be used by the deployment instance(s) 120. For example, the output of the neural network 118 can be used to modify configuration of deployment instance(s) 120. In a search context, example output of the neural network 118 can be used to select configuration, such as a layout of the return results and/or a number of advertisements in the user interface, that would increase the conversion rate based on the predictions from the neural network 118. The neural network application 116 can accelerate the inferences from the neural network 118 by determining and using precomputations, as described herein.

The machine learning instance(s) 110 can train the neural network 118 using training data from the training data storage 114. The machine learning instance(s) 110 can store the neural network 118 in the model data storage 112. The training data can include the interaction data received from the deployment instance(s) 120.

The model data storage 112 and/or the training data storage 114 may be embodied in hard disk drives, solid state memories, any other type of non-transitory computer-readable storage medium. The model data storage 112 and/or the training data storage 114 may also be distributed or partitioned across multiple local and/or remote storage devices. Each of the model data storage 112 and/or the training data storage 114 may include a data store. As used herein, in addition to its ordinary and customary meaning, a “data store” can refer to any data structure (and/or combinations of multiple data structures) for storing and/or organizing data, including, but not limited to, relational databases (e.g., Oracle databases, MySQL databases, etc.), non-relational databases (e.g., NoSQL databases, etc.), key-value databases, in-memory databases, tables in a database, comma separated values (CSV) files, eXtendible markup language (XML) files, TeXT (TXT) files, flat files, spreadsheet files, and/or any other widely used or proprietary format for data storage.

The network 106 may be any wired network, wireless network, or combination thereof. In addition, the network 106 may be a personal area network, local area network, wide area network, cable network, satellite network, cellular telephone network, or combination thereof. In addition, the network 106 may be an over-the-air broadcast network (e.g., for radio or television) or a publicly accessible network of linked networks, possibly operated by various distinct parties, such as the Internet. In some embodiments, the network 106 may be a private or semi-private network, such as a corporate or university intranet. The network 106 may include one or more wireless networks, such as a Global System for Mobile Communications (GSM) network, a Code Division Multiple Access (CDMA) network, a Long Term Evolution (LTE) network, or any other type of wireless network. The network 106 can use protocols and components for communicating via the Internet or any of the other aforementioned types of networks, such as HTTP. Protocols and components for communicating via the Internet or any of the other aforementioned types of communication networks are well known to those skilled in the art of computer communications and thus, need not be described in more detail herein.

The client computing devices 102 and the machine learning system 104 may each be embodied in a plurality of devices. For example, the client computing devices 102, the deployment instance(s) 120, and/or the machine learning instance(s) 110 may each include a network interface, memory, hardware processor, and non-transitory computer-readable medium drive, all of which may communicate with each other by way of a communication bus. The network interface may provide connectivity over the network 106 and/or other networks or computer systems. The hardware processor may communicate to and from memory containing program instructions that the hardware processor executes in order to operate the client computing devices 102, the deployment instance(s) 120, and/or the machine learning instance(s) 110. The memory generally includes RAM, ROM, and/or other persistent and/or auxiliary non-transitory computer-readable storage media.

Additionally, in some embodiments, the machine learning system 104 or components thereof (such as the deployment instance(s) 120 and the machine learning instance(s) 110) are implemented by one or more virtual machines implemented in a hosted computing environment. The hosted computing environment may include one or more rapidly provisioned and/or released computing resources. The computing resources may include hardware computing, networking and/or storage devices configured with specifically configured computer-executable instructions. A hosted computing environment may also be referred to as a “serverless,” “cloud,” or distributed computing environment.

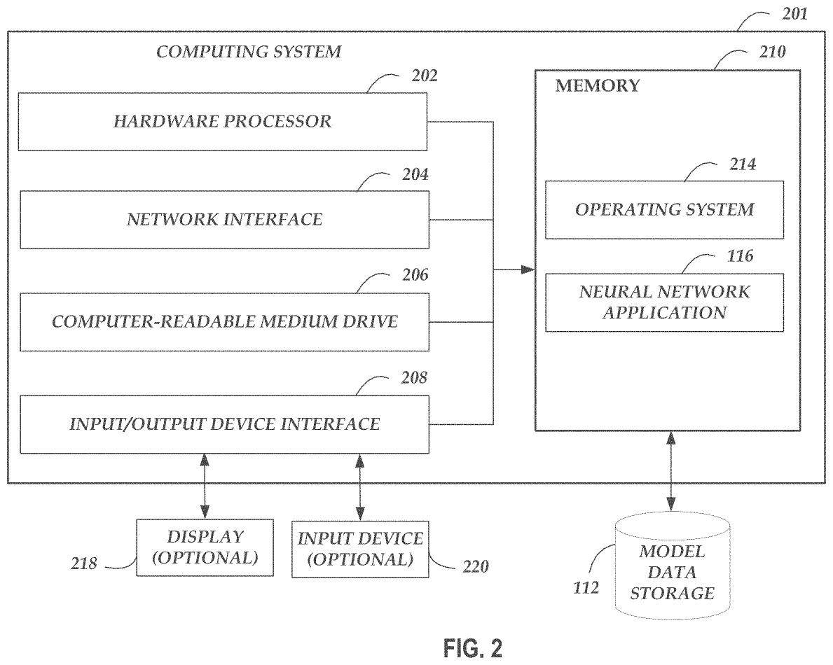

FIG. 2 is a schematic diagram of an illustrative general architecture of a computing system 201 for implementing the deployment instance(s) 120 and/or the machine learning instance 110 referenced in the environment 100 in FIG. 1. While the general architecture of the computing system 201 is shown and described with respect to FIG. 2, the general architecture of FIG. 2 can be used to implement other devices described herein, such as the client computing device 102 and/or the machine learning instance(s) 110. Those skilled in the art will appreciate that the computing system 201 may include more (or fewer) components than those shown in FIG. 2. Further, other computing systems described herein may include similar implementation arrangements of computer hardware and software components.

The computing system 201 for implementing the deployment instance 120 may include a hardware processor 202, a network interface 204, a non-transitory computer-readable medium drive 206, and an input/output device interface 208, all of which may communicate with one another by way of a communication bus. As illustrated, the computing system 201 is associated with, or in communication with, an optional display 218 and an optional input device 220. In other embodiments, the display 218 and input device 220 may be included in the client computing devices 102 shown in FIG. 1. The network interface 204 may provide the computing system 201 with connectivity to one or more networks or computing systems. The hardware processor 202 may thus receive information and instructions from other computing systems or services via the network 106. The hardware processor 202 may also communicate to and from memory 210 and further provide output information for an optional display 218 via the input/output device interface 208. The input/output device interface 208 may accept input from the optional input device 220, such as a keyboard, mouse, digital pen, touch screen, accelerometer, gyroscope, or gestures recorded via motion capture and/or image recognition (e.g., eye, hand, head, and/or body part placement and/or recognition). The input/output device interface 220 may also output audio data to speakers or headphones (not shown).

The memory 210 may contain specifically configured computer program instructions that the hardware processor 202 executes in order to implement one or more embodiments of the deployment instance(s) 120. The memory 210 generally includes RAM, ROM and/or other persistent or non-transitory computer-readable storage media. The memory 210 may store an operating system 214 that provides computer program instructions for use by the hardware processor 202 in the general administration and operation of the deployment instance 120. The memory 210 may further include other information for implementing aspects of the deployment instance(s) 120. For example, the memory 210 may communicate with the model data storage 112. In some embodiments, the model data storage 112 may store one or more data structures or objects that can also be loaded into the memory 210.

The memory 210 may include a neural network application 116 that may be executed by the hardware processor 202. In some embodiments, the neural network application 116 may implement various aspects of the present disclosure. For example, the neural network application 116 may calculate precomputed values that are used for inference acceleration using the techniques described herein.

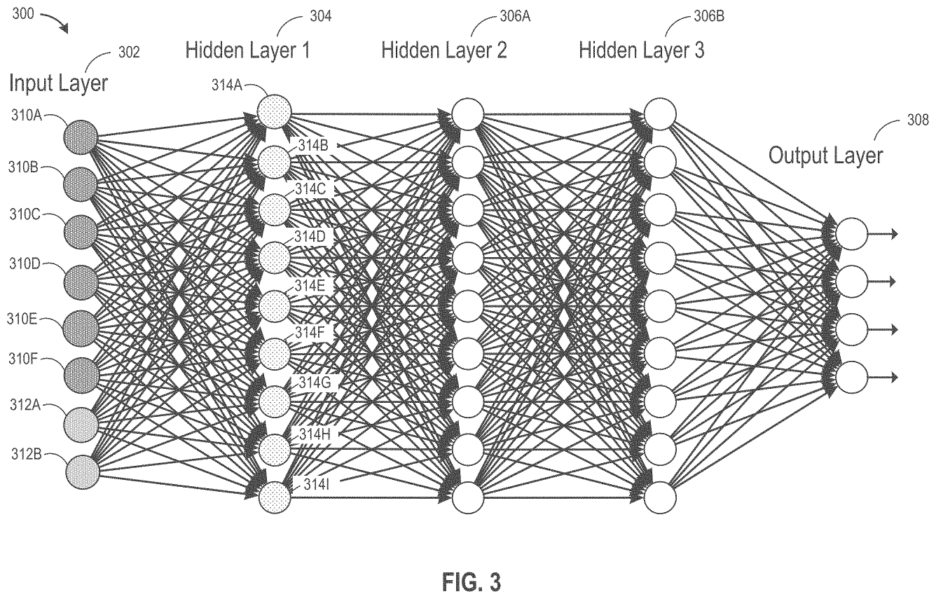

FIG. 3 is a schematic diagram depicting an example neural network 300. The neural network 300 includes an input layer 302, a first intermediate layer 304 and additional, optional intermediate layers 306A, 306B, and an output layer 308. The input layer 302 includes m input static features S 310A, 310B, 310C, 310D, 310E, 310F. The features S 310A, 310B, 310C, 310D, 310E, 310F are static in that they do not change for subsequent inference requests. However, if the neural network 300 were retrained, then the static features S 310A, 310B, 310C, 310D, 310E, 310F could change. The input layer 302 further includes n input features A 312A, 312B. The first intermediate layer 304 and the optional intermediate layers 306A, 306B includes nodes. In particular, the first intermediate layer 304 includes a first set of nodes 314A, 314B, 314C, 314D, 314E, 314F, 314G, 314H, 314I. The connections between the layers can be assigned weights. In particular, each connection between the input {s₁, s₂, . . . , sₘ, a₁, . . . , aₙ} 310A, 310B, 310C, 310D, 310E, 310F, 312A, 312B can be assigned weight values {w₁, w₂, . . . , wₘ₊ₙ}.

In some embodiments, the neural network 300 can estimate the reward function V(S,A) for a single agent. The static features S 310A, 310B, 310C, 310D, 310E, 310F can correspond to state features. The input features A 312A, 312B can correspond to action features.

A neural network application 116 can calculate the value at the node 314A in the first intermediate layer 304 by combining at least the input {s₁, s₂, . . . , sₘ, a₁, . . . , aₙ} 310A, 310B, 310C, 310D, 310E, 310F, 312A, 312B and the weight values {w₁, w₂, . . . , wₘ₊ₙ}. The neural network application 116 can calculate the value at the node 314A using an activation function g( ). In particular, the neural network application 116 can calculate the value at the node 314A with the following equation: g(b+Σᵢ₌₁^{m}sᵢwᵢ+Σᵢ₌₁ⁿaᵢwₘ₊ᵢ) where b is the bias term. The neural network application 116 can similarly calculate the values at the other nodes 314B, 314C, 314D, 314E, 314F, 314H, 314I in the first intermediate layer 304 of the neural network 300.

The neural network application 116 can advantageously reduce repetitive computations between the input layer 302 and the first intermediate layer 304. The neural network application 116 can precompute a portion of the input to the activation function in the first intermediate layer 304 that does not change. Specifically, where the bias term and the static feature values b+Σᵢ₌₁^{m}sᵢwᵢ do not change, the neural network application 116 can precompute this portion of the input before the learning process to avoid repeated calculations. The precomputation techniques described herein can be applied to (and lead to improvements) in the context of optimization problems and, in particular, argmax_{a∈A}V(S,A).

Big O notation can be used to describe the performance or complexity of an algorithm. Each run of the neural network 300 can be referred to as an inference request. In the examples of FIG. 3, the static feature vector 310A, 310B, 310C, 310D, 310E, 310F can be M dimensions, which means that there are M static feature inputs. Similarly, the input feature vector 312A, 312B can be N dimensions, which means that there are N feature inputs. The first intermediate layer 304 can be P dimensions, which means there are P nodes 314A, 314B, 314C, 314D, 314E, 314F, 314G, 314H, 314I in the first intermediate layer 304. With K inference requests, the performance of the neural network 300 to calculate the combined values between the input layer 302 and the first intermediate layer 304 can be represented in Big O notation as O((M+N)PK) without the performance improvements described herein. The foregoing Big O equation indicates that there will be (M+N) times P operations (since there are P nodes in the first intermediate layer 304), which is further multiplied by K because there are K inference requests.

However, with the performance improvements described herein, the corresponding Big O equation can be revised. Starting with the equation from before, O((M+N)PK), the (M+N) portion can be distributed. The N portion (which is the input feature vector 312A, 312B) multiplied by PK portion remains the same because the input feature vector 312A, 312B can change with each inference request. The performance savings of the neural network application 116 occur with respect to the M portion of the equation. Since the neural network application 116 precomputes M and M is fixed, the neural network application 116 can compute M once instead of K times. Thus, the M portion of the Big O equation can be represented as MP. Accordingly, the improved performance of the runtime execution of the neural network 300 can be represented as O(NPK+MP). A result of the savings from the precomputations by the neural network application 116 is that the runtime execution of the neural network 300 can be a much shorter than the runtime without the precomputations, as indicated by the foregoing Big O equations.

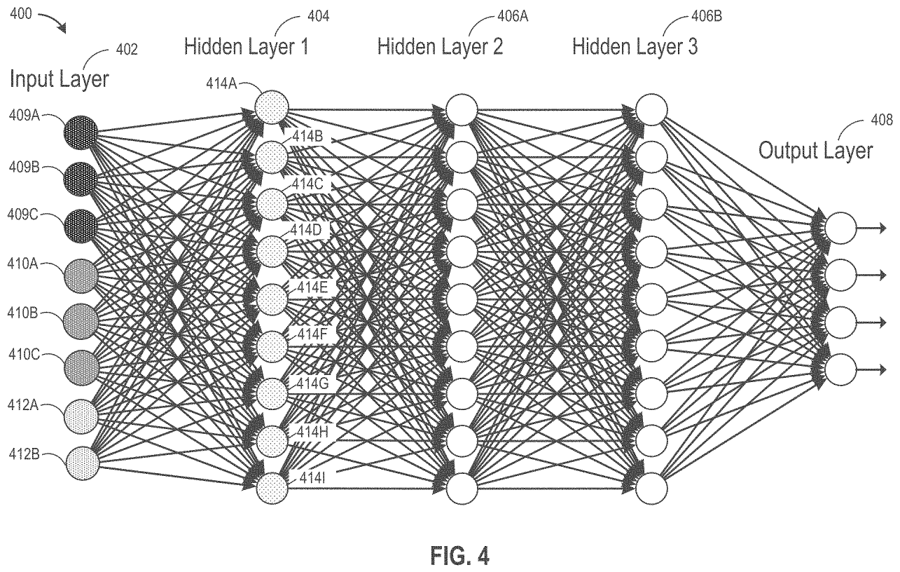

FIG. 4 is a schematic diagram depicting another example neural network 400. The neural network 400 of FIG. 4 can be similar to the neural network 300 of FIG. 3. For example, the neural network 400 includes an input layer 402, a first intermediate layer 404 and additional, optional intermediate layers 406A, 406B, a first node 414 of the first intermediate layer 404, and an output layer 408. Much like the neural network 300 of FIG. 3, the neural network 400 can include layer(s) 404, 406A, 406B with nodes and the connections between the layers can be assigned weights. In particular, the first intermediate layer 404 includes a first set of nodes 414A, 414B, 414C, 414D, 414E, 414F, 414G, 414H, 414I. However, unlike the neural network 300 of FIG. 3, which can be for a single agent, the neural network 400 can be for multiple agents. In multi-agent reinforcement learning, multiple agents participate and share a common environment. Example use cases for multi-agent reinforcement learning can include autonomous driving (each agent can be an individual car or class of cars), search (each agent can be an individual search or group of searches with common characteristics), logistics (each agent can be an individual product or group of products with common characteristics), and/or personalization (each agent can be a particular customer or group of customers with related characteristics).

In reinforcement learning, an example optimal policy for agent i can be defined as π^{i,*}=argmax_{a∈A}Vⁱ(S,A), where V is the reward function that maps from the states S and actions A to metrics that agent i tries to optimize. Agent features can be encoded as part of the state features to translate the problem back to a similar formulation as a single agent problem. In particular, the optimal policy equation can be rewritten as π^{i,*}=argmax_{a∈A}Vⁱ([Sⁱ,S^{e}],A), where Sⁱ are the agent features and S^{e} are the environment state features. The agent features and the environment features are described in further detail below with respect to the neural network 400 of FIG. 4.

As shown in the neural network 400 of FIG. 4, the input layer 402 includes M₁ input agent features Sⁱ 409A, 409B, 409C and M₂ input environment state features S^{e} 410A, 410B, 410C. The input layer 402 further includes N input action features A 412A, 412B. The first intermediate layer 404 has P nodes. Accordingly, the agent feature vector Sⁱ 409A, 409B, 409C is M₁ dimensions, the environment state feature vector S^{e} 410A, 410B, 410C is M dimensions, the action feature vector 412A, 412B is N dimensions, and the first intermediate layer 404 is P dimensions. As described herein, the machine learning application 215 can precompute the environment state feature vector S^{e}, which can result in performance improvements.

In the context of solving the optimization problem and, in particular, argmax_{a∈A}Vⁱ([Sⁱ,S^{e}],A), there can be K inference requests per agent and G agents. In Big O notation, without the performance improvements described herein, the performance of the neural network 400 to calculate the combined values between the input layer 402 and the first intermediate layer 404 can be represented as O((M₁+M₂+N)PKG). The foregoing Big O equation indicates that there will be (M₁+M₂+N) times P operations (since there are P nodes in the first intermediate layer 404), which is further multiplied by KG because there are K inference requests and G agents.

However, with the performance improvements described herein, the corresponding Big O equation for multiple agents can be revised. Starting with the equation for multiple agents from before, O((M₁+M₂+N)PKG), the (M₁+M₂+N) portion can be distributed. The (M₁+N), which are the agent feature vector 409A, 409B, 409C and the action feature vector 412A, 412B, multiplied by PKG portion remains the same because each of the agent feature vector 409A, 409B, 409C and the action feature vector 412A, 412B can change with each inference request and agent. The performance savings of the neural network application 116 occur with respect to the M₂ portion of the equation. Since the neural network application 116 precomputes M₂ and M₂ is fixed, the neural network application 116 can compute M₂ once instead of KG times. Thus, the M₂ portion of the Big O equation can be represented as M₂P. Accordingly, the improved performance of the runtime execution of the neural network 400 can be represented as O((M₁+N)PKG+M₂P). A result of the savings from the precomputations by the neural network application 116 is that the runtime execution of the neural network 400 of FIG. 4 can be a much shorter than the runtime execution without the precomputations, as indicated by the foregoing Big O equations.

In some cases, with multiple agents and the neural network 400 of FIG. 4, the neural network application 116 can achieve further performance improvements. In a multi-agent machine learning context, the agents can share the same set of environment state features and the same set of possible actions. For example, in the context of autonomous driving, the possible actions for all the cars can include speed up/down, steer right/left, etc. In the context of solving the optimization problem and, in particular, argmax_{a∈A}Vⁱ([Sⁱ,S^{e}],A), there can be T possible environment states, C possible actions, K inference requests per agent, and G agents. Thus, the neural network application 116 can encode the first intermediate layer 404 with precomputed dot products for all possible environment states T and all possible actions C.

In Big O notation, without the performance improvements described herein, the performance of the neural network 400 to calculate the combined values between the input layer 402 and the first intermediate layer 404 can be represented as O((M₁+M₂+N)PKGTC). The foregoing Big O equation indicates that there will be (M₁+M₂+N) times P operations (since there are P nodes in the first intermediate layer 404), further multiplied by KG because there are K inference requests and G agents, and yet further multiplied by TC because there are T possible environmental states and C possible actions.

However, with the performance improvements described herein, the corresponding Big O equation for multiple agents and shared actions can be revised. Starting with the equation for multiple agents from before, O((M₁+M₂+N)PKGTC), the (M₁+M₂+N) portion can be distributed. The agent feature vector M₁ 409A, 409B, 409C is multiplied by the PKG portion remains the same because the agent feature vector M₁ 409A, 409B, 409C can change with each inference request and agent. The performance savings of the neural network application 116 occur with respect to the M₂ and N portions of the equation. Since the neural network application 116 precomputes environment state features M₂ and M₂ is fixed, the neural network application 116 can compute M₂TC once instead of KG times. Thus, the M₂ portion of the Big O equation can be represented as M₂PTC. Similarly, the neural network application 116 precomputes action features N and N is fixed, the neural network application 116 can compute NC once instead of KG times. Thus, the N portion of the Big O equation can be represented as NPC.

Accordingly, the improved performance of the runtime execution of the neural network 400 can be represented as O(M₁PKG+M₂PTC+NPC). A result of the savings from the precomputations (which include shared actions) by the neural network application 116 is that the runtime execution of the neural network 400 of FIG. 4 by its host computer can be a much shorter than the runtime execution without the precomputations, as indicated by the foregoing Big O equations. In particular, with the performance improvements, as T, C, and N increases, time complexity increases linearly whereas in the naive approach without the performance improvements the time complexity increases exponentially.

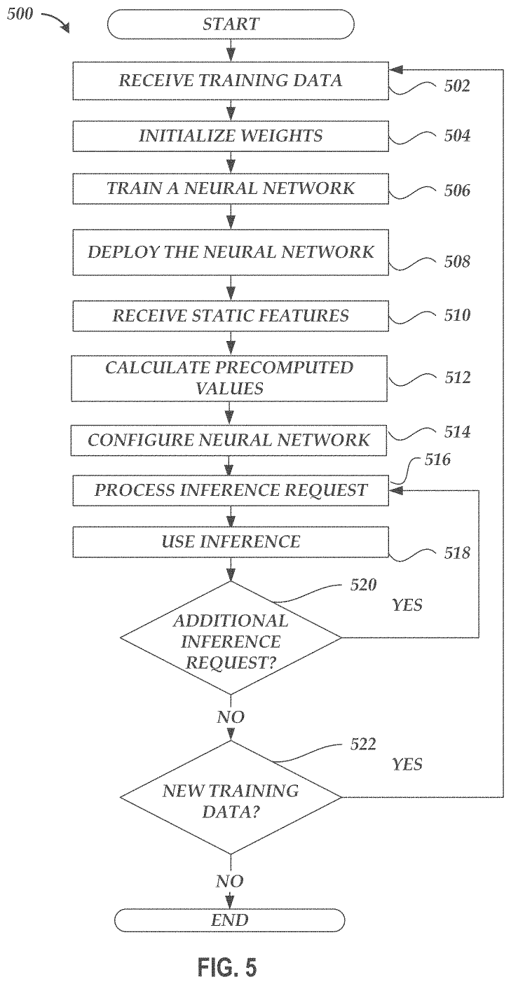

FIG. 5 is a flow diagram depicting an example method 500 implemented by the machine learning system 104 for accelerated neural network inferences. As described herein, the machine learning system 104 may include the deployment instance(s) 120. In some embodiments, the deployment instance(s) 120 may include the neural network application 116, and may implement aspects of the method 500. Some aspects of the method 500 may be implemented by other components of the machine learning system 104, such as the machine learning instance(s) 110. Moreover, some aspects of the method 500 may be described above with respect to FIGS. 3 and 4.

Beginning at block 502, training data can be received. In particular, the machine learning instance 110 can receive the training data. In some embodiments, the deployment instance(s) 120 can generate the training data. Example training data can include user interaction data, such as historical signals indicating prior user interactions. Example historical signals can include a number of selections (e.g., clicks) for a particular brand received during a time period, a number of times movies of particular actor were consumed, or number of acquisitions by a user. Additional historical signals can indicate selections (e.g., clicks), acquisitions, or views of an item.

At block 504, weights can be initialized. In particular, the machine learning instance 110 can initialize weight values for use in a neural network. As described herein, each node in a neural network can be connected with each node from the next layer in the neural network and each connection can have a particular weight. In some embodiments, the machine learning instance 110 can initialize the weight values to a default value, such as one. In other embodiments, the machine learning instance 110 can initialize each weight value to a pseudo-random or random value. As the machine learning instance 110 trains a neural network, the weight values can be adjusted. The machine learning instance 110 can initialize other values associated with a neural network, such as the bias for the activation function of a node. In some embodiments, the machine learning instance 110 can initialize the bias values to a default value, such as zero. Much like the weight values that the machine learning instance 110 can adjust through training, bias can be adjusted by the machine learning instance 110 through training. In some embodiments, the machine learning instance 110 can initialize the weight values and biases from an existing or previously trained neural network.

At block 506, a neural network can be trained. In particular, the machine learning instance 110 can train a neural network. The machine learning instance 110 can train the neural network using the initial weight values, the bias values, and the training data. The machine learning instance 110 can train the neural network using one or more methods. During training, the machine learning instance 110 can adjust the weights of the neural network. In some embodiments, the machine learning instance 110 can similarly adjust the bias values and/or other neural network parameters. The machine learning instance 110 can adjust the weight values based at least in part on output from the output layer. For example, the machine learning instance 110 can apply a gradient descent algorithm, which includes a numeric calculation to adjust the weights and/or other parameters such that the output deviation is minimized. The machine learning instance 110 can adjust the weight values based at least in part on a loss function applied to output from the output layer. An example loss function maps a set of parameter values for the neural network onto a scalar value that indicates how well those parameters accomplish the task the neural network is intended to do. The machine learning instance 110 can store the trained neural network in the model data storage 112.

At block 508, the trained neural network can be deployed. For example, a deployment instance 120 can receive a trained neural network from the model data storage 112. As described herein, the deployment instance 120 can be a system, such as, but not limited to, a search, computer vision, speech processing, natural language processing, information retrieval, and/or autonomous driving system. For example, an input value to the input layer of the neural network can correspond to search text of a search query and the output layer of the neural network can predict a conversion rate for the search text. Additional example output from the output layer can include a value associated with a user acquisition prediction. Before the neural network application 116 processes inference requests, the neural network application 116 can calculate the precomputed values and configure an improved neural with the precomputed values to process the inference requests faster, as described in the below blocks.

At block 510, static features can be received. In particular, the neural network application 116 can receive the static features in a feature vector. In other embodiments, the neural network application 116 can receive data and transform the data into a feature vector. A feature vector can be a numerical representation of one or more features. There can be a one-to-one correspondence between a numerical representation of a feature value and the feature value itself. For example, “Monday” can be assigned a numerical value of 1 in a feature vector and “Tuesday” can be assigned a numerical value of 2 in the same and/or a different feature vector.

As described below with respect to the next block for precomputing values, the static feature values can be used by the neural network application 116 in precomputations. The static feature values do not change for subsequent inference requests, and, therefore, the neural network application 116 may use those static feature values in precomputations. Example static feature values can include or correspond to temporal features. Example temporal features can include day of week, month, year, etc. Similarly, in scenarios where agents share the same possible actions, all possible environment states and possible actions may be received by the neural network application 116 for use in precomputations. In some embodiments, the static feature values can correspond to state feature values.

At block 512, precomputed values can be calculated. In particular, the neural network application 116 can calculate the precomputed values from the static feature values in the connections from the input layer to a first intermediate layer. For example, since the static feature values {s₁, s₂, . . . , sₘ} do not change for multiple inferences, the neural network application 116 can precompute this portion of the input before an inference request is received to avoid repeated calculations. The neural network application 116 can calculate a set of precomputed values from at least the bias values, the state static feature values, and corresponding weight values. In particular, each static feature value {s₁, s₂, . . . , sₘ} can be assigned a weight value {w₁, w₂, . . . , wₘ}. Thus, the neural network application 116 can calculate the precomputed values by combining the static feature values and the corresponding weight values (e.g., Σᵢ₌₁^{m}sᵢwᵢ). Moreover, if there is a bias, the neural network application 116 can precompute a portion of the input with the bias (e.g., b+Σᵢ₌₁^{m}sᵢwᵢ). Additional details regarding precomputations by the neural network application 116 are described above with respect to FIG. 3.

In some embodiments, additional input values can be precomputed. In a multi-agent machine learning context, if the agents can share the same set of environment state features and the same set of possible actions, then the neural network application 116 can further combine the possible environment states and the possible actions in the precomputed values. In particular, the neural network application 116 can calculate combined values from at least the bias values, the state feature values, corresponding weight values, the set of environment states, and/or the set of shared actions. The neural network application 116 can assign the combined values to the set of precomputed values for later use. Additional details regarding further precomputations by the neural network application 116 are described above with respect to FIG. 4.

At block 514, a neural network can be configured. In particular, the neural network application 116 can configure a neural network from the trained neural network. As used herein, the neural network may be referred to as a “partially precomputed neural network” since the neural network can include some precomputed values within the neural network itself. The neural network can be a data structure including interconnected nodes, an input layer, a first intermediate layer, and an output layer. The neural network application 116 can configure the neural network by assigning the weight values to connections between the layers of the neural network and by including the set of precomputed values into the neural network itself. The neural network can be defined at least in part by the plurality of weight values between the input layer, the first layer, and the output layer. In some embodiments, despite the arrangement of the blocks of the method 500, training of the neural network can include calculating the set of precomputed values. For example, the machine learning instance 110 can train a neural network, calculate the precomputed set of values, and include the precomputed set of values into the neural network.

At block 516, an inference request can be processed. In particular, the neural network application 116 can process an inference request in an accelerated manner. For each inference request, the neural network application 116 can receive a set of input feature values. For each inference request, the set of input feature values can change. The neural network application 116 can apply, in the first intermediate layer, an activation function to at least the precomputed values, the input feature values, and second weight values associated with the input feature values. For example, with an activation function g( ), the neural network application 116 can calculate the value at a node in the first intermediate layer with the following equation: g(b+Σᵢ₌₁^{m}sᵢwᵢ+Σᵢ₌₁ⁿaᵢwₘ₊ᵢ), where a portion of the input has been precomputed already. The neural network application 116 can receive output from the activation function. As described herein, the neural network application 116 can determine an inference based at least in part on the output from the activation function. For example, the neural network application 116 can determine an inference from the output at the particular node and the remainder of the neural network. In some embodiments, the input feature values can correspond to action feature values.

In some embodiments, the neural network can be further configured to process multiple agents and receive an agent feature vector as input. The neural network application 116 can receive agent feature values at the input layer that are associated with corresponding weight values. Application of the activation function for an inference request can further include the neural network application 116 calculating combined values from at least the precomputed values, the input feature values, the agent feature values, and corresponding weight values. The neural network application 116 can provide the combined values to the activation function as input. In a search context, the agent feature values can represent a collection of search queries, such as a collection search queries associated with a performer or with a type of electronic product (such as a brand of smartphone or laptop). In the search context, some example agent feature values can represent or correspond to a number of advertisements to be shown in a search user interface. Additional example agent features can indicate a type of computing device that issued a search, such as a smartphone, laptop, desktop, etc., and this type of feature can also be referred to as a search channel. Yet another example agent feature can indicate a customer type, such as whether a customer profile is a member of a paid subscription program or not and/or is some other type of priority customer.

At block 518, the inference can be used. In particular, the deployment instance 120 can use the inference from the neural network. For example, the client computing device 102 can submit a request to the deployment instance 120. Based at least in part on the request, the deployment instance 120 can receive an inference from the neural network in an accelerated manner and can use the inference to configure some aspect of the deployment instance 120 (such as a user interface), for example. As described herein, the inference from the neural network can predict a conversion rate for the search text, which can be used to configure a search system of the deployment instance 120. An additional example inference from the output layer of the neural network can include a value associated with a user acquisition prediction, which can be used by the deployment instance 120 to configure some aspect of a user interface, for example.

At block 520, it can be determined whether there are additional inference requests for processing. The neural network application 116 can determine whether there are additional inference requests that have not been processed by the neural network. For example, different client computing devices 102 can cause a respective inference request to be submitted to the neural network application 116. Additionally or alternatively, the inference requests can be stored in a data structure and the neural network application 116 can process inference requests until there are not any more left or some other condition is satisfied. If there is an additional inference request, the method 500 can return to the block 516 for processing inference requests. Otherwise, the method 500 can proceed to the block 522 for checking for new training data.

Returning to block 516, an additional inference request can be processed. For example, for an additional inference request, the neural network application 116 can receive additional (such as second) input feature values that are different from the input feature values from a previous inference request. The neural network application 116 can apply, in the first intermediate layer, at least the activation function to the precomputed values, the additional input feature values, and corresponding weight values. The neural network application 116 can apply the activation function for an additional inference request by reusing the set of precomputed values, where reusing the set of precomputed values can avoid repeating calculation(s) by a computer hardware processor for the additional inference request. In other words, instead of calculating some values for multiple inference requests without those values changing, the neural network application 116 can achieve performance improvements by using the precomputed values, thereby avoiding some repeated calculations. The neural network application 116 can receive second output from the activation function. The neural network application 116 can determine a second inference based at least in part on the second output from the activation function at a particular node. For example, the neural network application 116 can determine the second inference from the output at the particular node and the remainder of the neural network.

At block 518, the second inference can be used. In particular, the deployment instance 120 can use the second inference in a similar manner as the instance 120 used the first inference. At block 520, it can be determined whether there are additional inference requests for processing again. If there are no additional inference requests, the method 500 can proceed to block 522 to check for new training data.

At block 522, it can be determined whether there is new training data. The neural network application 116 can determine whether there is new training data for training or retraining a neural network. As described herein, the new training data can include additional interaction data received by the deployment instance(s). Accordingly, if there is new training data, the machine learning instance 110 can return to the block 502 for receiving the training data and ultimately training a new neural network or retraining an existing neural network, where either after or during the training or retraining, the set of precomputed values can be calculated for the new neural network.

Testing of the improvements described herein can confirm the performance benefits and the improvements to the functioning of a computer itself. In some embodiments, a host computing device with multiple graphics processing units (GPUs) can be useful for machine learning. An example high-performance host computing device can include the following specifications: up to eight GPUs with 128 gigabytes (GiB) of GPU memory, a 300 gigabytes per second (GBps) direct GPU-to-GPU interconnect, 64 virtual CPUs, 488 GiB of main memory, and 25 gigabits per second (Gbps) of network bandwidth. Multi-agent tests can be performed on the host computing device.

In a first scenario, neural network inference requests can be processed on the same host computing device (i) without the performance improvements and (ii) with the performance improvements. In the first scenario, the input layer can include M₁ input agent features, where M₁=300. The input layer can further include M₂ input environment state features, where M₂=9. The input layer can further include N input action features, where N=1. The first intermediate layer can have P nodes, where P=48. In the first scenario, there can be K=1 inference requests per agent and G=5000 agents. There can be T=3*3*2 or 18 possible environment states and C=167 possible actions. The batch size can be set to 5,000. Under the first scenario, without the performance improvements described herein, processing of inference requests with the neural network can take approximately one minute and eighteen seconds. However, under the first scenario and with the performance improvements described herein, processing of inference requests with the neural network can take approximately 3.2 seconds, which is approximately a twenty-four times faster runtime than the runtime without the performance improvements.

In a second scenario, neural network inference requests can again be processed on the same host computing device (i) without the performance improvements and (ii) with the performance improvements. The second scenario can be nearly identical to the first scenario. The input layer can include M₁ input agent features, where M₁=300. The input layer can further include M₂ input environment state features, where M₂=9. The input layer can further include N input action features, where N=1. The first intermediate layer can have P nodes, where P=48. There can be K=1 inference requests per agent. There can be T=3*3*2 or 18 possible environment states and C=167 possible actions. However, under the second scenario, there can be G=100,000 agents. The batch size can be set to 10,000. Under the second scenario, without the performance improvements described herein, processing of inference requests with the neural network can take approximately twenty-six minutes and thirty-four seconds. However, under the second scenario and with the performance improvements described herein, processing of inference requests with the neural network can take approximately 8.76 seconds, which is approximately a one-hundred and eighty-two times faster runtime than the runtime without the performance improvements.

In a second scenario, neural network inference requests can be attempted to be processed on one or more host computing devices (i) without the performance improvements and (ii) with the performance improvements. In the third scenario, the input layer can include M₁ input agent features, where M₁=300. The input layer can further include M₂ input environment state features, where M₂=9. The input layer can further include N input action features, where N=1. The first intermediate layer can have P nodes, where P=48. There can be K=1 inference requests per agent. There can be T=3*3*2 or 18 possible environment states and C=167 possible actions. However, under the third scenario, there can be G=1,000,000 agents. The batch size can be set to 10,000. Under the third scenario, without the performance improvements described herein, processing of inference requests with the neural network may not be possible on a single host device. Instead the performance time may have to be extrapolated from the second scenario for an estimated time of two-hundred and sixty-five minutes. However, under the second scenario and with the performance improvements described herein, processing of inference requests with the neural network can be possible on a single host device and can take approximately one minute and twenty-seven seconds, which is approximately a one-hundred and eighty times faster runtime than the runtime without the performance improvements.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Further, the term “each”, as used herein, in addition to having its ordinary meaning, can mean any subset of a set of elements to which the term “each” is applied.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A computer-implemented method for accelerating neural network inferences comprising:
under control of a computer hardware processor configured with specific computer executable instructions,
receiving a neural network comprising a plurality of weight values and a plurality of bias values;
receiving a plurality of static feature values, wherein the plurality of static feature values do not change for subsequent inference requests;
calculating a set of precomputed values from at least the plurality of bias values, the plurality of static feature values, and first weight values of the plurality of weight values associated with the plurality of static feature values;
configuring a partially precomputed neural network from the neural network and the set of precomputed values, the partially precomputed neural network comprising a plurality of interconnected nodes, an input layer, a first layer, and an output layer, the partially precomputed neural network defined at least in part by the plurality of weight values between the input layer, the first layer, and the output layer;
for a first inference request,
receiving a first plurality of feature values;
applying, in the first layer for a first time, an activation function to at least the set of precomputed values, the first plurality of feature values, and second weight values of the plurality of weight values associated with the first plurality of feature values, wherein applying the activation function the first time further comprises:
receiving first output from the activation function; and
determining a first inference based at least in part on the first output; and
for a second inference request,
receiving a second plurality of feature values different from the first plurality of feature values;
applying, in the first layer for a second time, the activation function to at least the set of precomputed values, the second plurality of feature values, and the second weight values further associated with the second plurality of feature values, wherein applying the activation function the second time further comprises:
reusing the set of precomputed values, wherein reusing the set of precomputed values avoids repeating at least one calculation by the computer hardware processor for the second inference request; and
receiving second output from the activation function; and
determining a second inference based at least in part on the second output.

2. The computer-implemented method of claim 1, wherein an input value to the input layer corresponds to search text of a search query and the output layer predicts a conversion rate for the search text.

3. The computer-implemented method of claim 1, wherein the partially precomputed neural network is further configured to maximize performance of an agent.

4. The computer-implemented method of claim 1, wherein the partially precomputed neural network is further configured to process multiple agents and receive an agent feature vector as input.

5. The computer-implemented method of claim 4, wherein the plurality of weight values further comprise third weight values, and wherein the computer-implemented method further comprises:
receiving a plurality of agent feature values associated with the third weight values, wherein applying the activation function for the first time further comprises:
calculating combined values from at least the set of precomputed values, the first plurality of feature values, the second weight values, the plurality of agent feature values, and the third weight values; and
providing the combined values to the activation function as input.

6. The computer-implemented method of claim 4, further comprising:
receiving a set of environment states; and
receiving a set of shared actions for the multiple agents, wherein calculating the set of precomputed values further comprises:
calculating combined values from at least the plurality of bias values, the plurality of static feature values, the first weight values, the set of environment states, and the set of shared actions; and
assigning the combined values to the set of precomputed values.

7. A system comprising:
a data storage medium; and
one or more computer hardware processors in communication with the data storage medium, wherein the one or more computer hardware processors are configured to execute computer-executable instructions to at least:
receive a plurality of weight values and a plurality of bias values;
receive a plurality of static feature values, wherein the plurality of static feature values do not change for subsequent inference requests;
calculate a set of precomputed values from at least the plurality of bias values, the plurality of static feature values, and first weight values of the plurality of weight values associated with the plurality of state feature values;
configure a neural network from the set of precomputed values, the neural network comprising a plurality of interconnected nodes, an input layer, a first layer, and an output layer, the neural network defined at least in part by the plurality of weight values between the input layer, the first layer, and the output layer; and
for a first inference request,
receive a first plurality of feature values;
apply, in the first layer for a first time, an activation function to at least the set of precomputed values, the first plurality of feature values, and second weight values of the plurality of weight values associated with the first plurality of feature values, wherein to apply the activation function the first time, the one or more computer hardware processors are configured to execute the computer-executable instructions to at least:
receive first output from the activation function; and
determine a first inference based at least in part on the first output; and
for a second inference request,
receive a second plurality of feature values different from the first plurality of feature values;
apply, in the first layer for a second time, the activation function to at least the set of precomputed values, the second plurality of feature values, and the second weight values further associated with the second plurality of feature values, wherein to apply the activation function the second time, the one or more computer hardware processors are configured to execute the computer-executable instructions to at least:
reuse the set of precomputed values; and
receive second output from the activation function; and
determine a second inference based at least in part on the second output.

8. The system of claim 7, wherein at least some of the plurality of static feature values correspond to temporal feature values.

9. The system of claim 7, wherein the plurality of static feature values correspond to state feature values.

10. The system of claim 7, wherein the first plurality of feature values correspond to action feature values.

11. The system of claim 7, wherein the neural network is further configured to process multiple agents and receive an agent feature vector as input, wherein the plurality of weight values further comprise third weight values, and wherein the one or more computer hardware processors are configured to execute additional computer-executable instructions to at least:
receive a plurality of agent feature values associated with the third weight values, wherein to apply the activation function the first time, the one or more computer hardware processors are configured to execute the additional computer-executable instructions to at least:
calculate combined values from at least the set of precomputed values, the first plurality of feature values, the second weight values, the plurality of agent feature values, and the third weight values; and
provide the combined values to the activation function as input.

12. The system of claim 11, wherein the plurality of agent feature values represent a collection of search queries.

13. The system claim 7, wherein the neural network is further configured to process multiple agents, wherein the one or more computer hardware processors are configured to execute additional computer-executable instructions to at least:
receive a set of environment states; and
receive a set of shared actions for the multiple agents, wherein to calculate the set of precomputed values, and wherein the one or more computer hardware processors are configured to execute the additional computer-executable instructions to at least:
calculate combined values from at least the plurality of bias values, the plurality of static feature values, the first weight values, the set of environment states, and the set of shared actions; and
assign the combined values to the set of precomputed values.

14. A system comprising:
a data storage medium; and
one or more computer hardware processors in communication with the data storage medium, wherein the one or more computer hardware processors are configured to execute computer-executable instructions to at least:
receive a plurality of weight values;
receive a plurality of static feature values, wherein the plurality of static feature values do not change for subsequent inference requests;
calculate a set of precomputed values from the plurality of static feature values, and first weight values of the plurality of weight values associated with the plurality of static feature values;
configure a neural network comprising the set of precomputed values, a plurality of interconnected nodes, an input layer, a first layer, and an output layer, the neural network defined at least in part by the plurality of weight values between the input layer, the first layer, and the output layer; and
for a first inference request,
receive a first plurality of feature values;
apply, in the first layer for a first time, an activation function to at least the set of precomputed values, the first plurality of feature values, and second weight values of the plurality of weight values associated with the first plurality of feature values, wherein to apply the activation function the first time, the one or more computer hardware processors are configured to execute the computer-executable instructions to at least:
receive first output from the activation function; and
determine a first inference based at least in part on the first output; and
for a second inference request,
receive a second plurality of feature values different from the first plurality of feature values;
apply, in the first layer for a second time, the activation function to at least the set of precomputed values, the second plurality of feature values, and the second weight values further associated with the second plurality of feature values, wherein to apply the activation function the second time, the one or more computer hardware processors are configured to execute the computer-executable instructions to at least:
reuse the set of precomputed values; and
receive second output from the activation function; and
determine a second inference based at least in part on the second output.

15. The system of claim 14, wherein at least some of the plurality of feature values correspond to a number of advertisements to be shown in a search user interface.

16. The system of claim 14, wherein the first inference comprises a value associated with a user acquisition prediction.

17. The system of claim 14, wherein the neural network is further configured to process multiple agents and receive an agent feature vector as input, wherein the plurality of weight values further comprise third weight values, and wherein the one or more computer hardware processors are configured to execute additional computer-executable instructions to at least:
receive a plurality of agent feature values associated with the third weight values, wherein to apply the activation function the first time, the one or more computer hardware processors are configured to execute the additional computer-executable instructions to at least:
calculate combined values from at least the set of precomputed values, the first plurality of feature values, the second weight values, the plurality of agent feature values, and the third weight values; and
provide the combined values to the activation function as input.

18. The system of claim 17, wherein an agent feature value indicates a type of computing device that issued a search.

19. The system of claim 17, wherein an agent feature value indicates a customer type.

20. The system claim 14, wherein the neural network is further configured to process multiple agents, and wherein the one or more computer hardware processors are configured to execute additional computer-executable instructions to at least:
receive a set of environment states; and
receive a set of shared actions for the multiple agents, wherein to calculate the set of precomputed values, the one or more computer hardware processors are configured to execute the additional computer-executable instructions to at least:
calculate combined values from at least the plurality of static feature values, the first weight values, the set of environment states, and the set of shared actions; and
assign the combined values to the set of precomputed values.
